(19) United States
(12) Patent Application Publication
(10) Pub. No.: US 2026/0330752 A1
(43) Pub. Date: Oct. 22, 2026

(54) IMAGE PROCESSING APPARATUS AND IMAGE PROCESSING METHOD

(71) Applicant: CANON KABUSHIKI KAISHA, Tokyo (JP)

(72) Inventor: Yoichi TAKIKAWA, Tokyo (JP)

(21) Appl. No.: 19/649,236

(22) Filed: Apr. 16, 2026

(30) Foreign Application Priority Data
Apr. 22, 2025 (JP) 2025-070797

(51) Int. Cl. G06T 15/20; G06T 7/70

(52) U.S. Cl. CPC G06T 15/205; G06T 7/70; G06T 2207/20081; G06T 2207/30204

(57) ABSTRACT

An image processing apparatus includes a first generation unit that generates a first generated image based on a first image and a second generation unit that generates a second generated image based on the first generated image and a second image. The first generation unit and the second generation unit respectively generate the first generated image and the second generated image using a generative AI model trained so as to generate an output image by reconstructing a part of an input image.

### BACKGROUND

### Field of the Technology

The present disclosure relates to image generation processing.

### Description of the Related Art

Japanese Patent Laid-Open No. 2023-110921 describes a method of generating an extended image from an input image using a learned Artificial Intelligence (AI) model. As methods of generating an extended image, there are provided methods called inpainting for replacing a part of an image with another image and removing an unnecessary portion of the image and outpainting for adding a missing portion of an image.

Japanese Patent Laid-Open No. 2023-110921 does not assume that image generation is performed from a plurality of images obtained by capturing the same scene from different viewpoints. Therefore, if image generation is performed from each of a plurality of images with different viewpoints, inconsistent images may be generated even from the images obtained by capturing the same scene.

### SUMMARY

The present disclosure has been made in consideration of the aforementioned problems, and provides technical advantages in generating, when performing image generation from each of a plurality of images with different viewpoints, images that are consistent as images obtained by capturing the same scene.

In order to solve the aforementioned problems, the present disclosure is directed to an image processing apparatus comprising: at least one processor; and at least one memory which stores a program which, when executed by the at least one processor, causes the image processing apparatus to function as: a first generation unit that generates a first generated image based on a first image; and a second generation unit that generates a second generated image based on the first generated image and a second image, wherein the first generation unit and the second generation unit respectively generate the first generated image and the second generated image using a generative AI model trained so as to generate an output image by reconstructing a part of an input image.

According to the present disclosure, when performing image generation from each of a plurality of images with different viewpoints, it is possible to generate images that are consistent as images obtained by capturing the same scene.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view showing a system configuration according to a first embodiment;

FIGS. 2A and 2B are block diagrams respectively exemplifying apparatus configurations according to the first embodiment;

FIG. 3 is a flowchart exemplifying control processing according to the first embodiment;

FIG. 4 is a view illustrating a method of training a first generative AI model according to the first embodiment;

FIG. 5 is a view illustrating a method of training a second generative AI model according to the first embodiment;

FIG. 6 is a view showing a system configuration according to a second embodiment;

FIG. 7 is a block diagram exemplifying an apparatus configuration according to the second embodiment;

FIG. 8 is a flowchart exemplifying control processing according to the second embodiment; and

FIG. 9 is a view illustrating a method of training a second generative AI model according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

A first embodiment will be described below.

### System Configuration

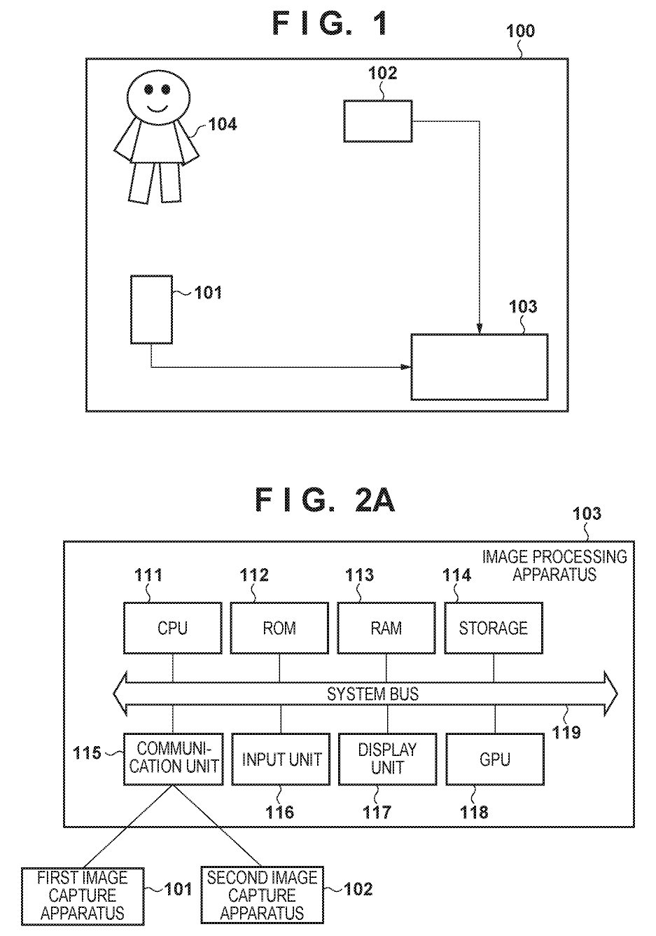

First, a system configuration according to this embodiment will be described with reference to FIG. 1.

FIG. 1 exemplifies the configuration of an image capture system according to this embodiment.

An image capture system 100 according to this embodiment includes a first image capture apparatus 101, a second image capture apparatus 102, and an image processing apparatus 103.

Each of the first image capture apparatus 101 and the second image capture apparatus 102 is a digital camera that captures an image such as a still image or a moving image. The first image capture apparatus 101 and the second image capture apparatus 102 are arranged to capture a subject 104 from different viewpoints, and output captured images to the image processing apparatus 103.

The image processing apparatus 103 is a general-purpose computer or dedicated computer that executes image generation processing. The image processing apparatus 103 generates a new image from the images acquired from the first image capture apparatus 101 and the second image capture apparatus 102, and records it.

### Configuration of Image Processing Apparatus 103

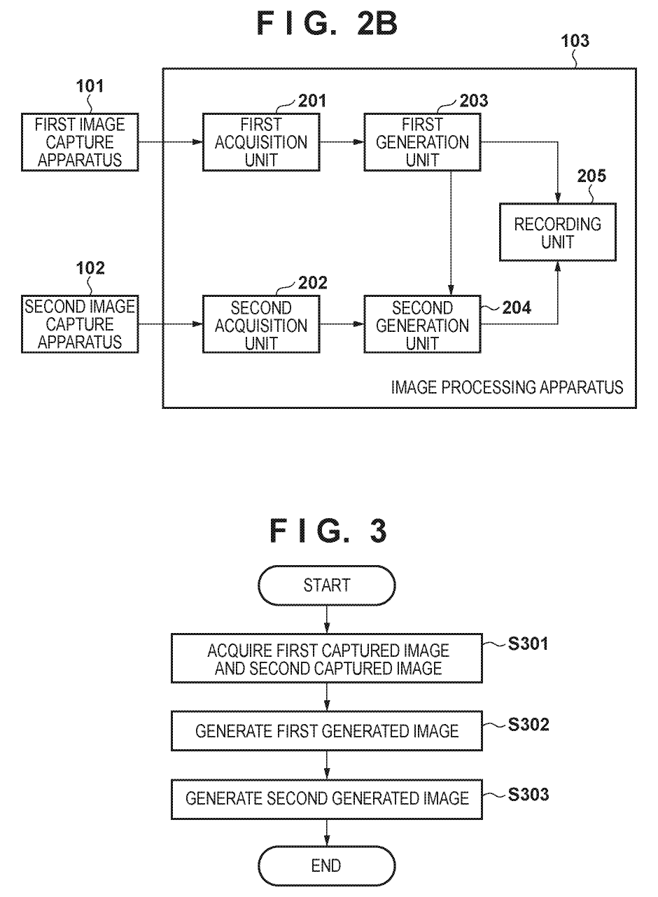

The configuration of the image processing apparatus 103 according to this embodiment will be described next with reference to FIGS. 2A and 2B.

FIG. 2A is a block diagram exemplifying the hardware configuration of the image processing apparatus 103 according to this embodiment.

The image processing apparatus 103 includes a CPU 111, a ROM 112, a RAM 113, a storage 114, a communication unit 115, an input unit 116, a display unit 117, and a GPU 118, and these components are connected via an internal bus 119 to be able to exchange data.

The CPU 111 is a control unit that controls the operation of the image processing apparatus 103. The CPU 111 controls the components (to be described later) to perform an operation corresponding to data input from the input unit 116 and data received from the communication unit 115.

The ROM 112 is a nonvolatile memory, and stores a program for controlling the image processing apparatus 103. When the power of the image processing apparatus 103 is turned on, the CPU 111 starts to control the image processing apparatus 103 by loading the program stored in the ROM 112 into the RAM 113 and executing it. The ROM 112 is, for example, a nonvolatile memory such as a flash memory.

The RAM 113 is a rewritable memory and is used as a work area by the program that controls the image processing apparatus 103. As the RAM 113, for example, a volatile memory (DRAM) using a semiconductor element is used.

The storage 114 is a mass storage unit that stores image data received from the first image capture apparatus 101 and the second image capture apparatus 102, image data generated by the image processing apparatus, and the like. The storage 114 is, for example, a hard disk drive (HDD) using a magnetic storage scheme or a solid-state drive (SSD) using a semiconductor element.

The communication unit 115 is connected to an external apparatus such as the first image capture apparatus 101 and the second image capture apparatus 102 via a network such as a wired LAN or a wireless LAN, and can transmit/receive data to/from the external apparatus. The CPU 111 implements communication with the external apparatus by controlling the communication unit 115. Note that a communication method is Ethernet^{®}, Wi-Fi^{®}, IEEE1394, or the like.

The input unit 116 is used by the user of the image processing apparatus 103 to operate the image processing apparatus 103. The input unit 116 is, for example, an input device such as a keyboard or a mouse. In this embodiment, the user inputs an instruction to execute learning processing or inference processing (to be described later) via the input unit 116 of the image processing apparatus 103.

The display unit 117 is used to display the operation state of the image processing apparatus 103. The display unit 117 is, for example, a display device such as a liquid crystal display or an organic EL display. Note that the image processing apparatus 103 according to this embodiment can take a form in which the display unit 117 is omitted.

The Graphics Processing Unit (GPU) 118 is a processor that performs parallel arithmetic processing of data. The GPU 118 can perform efficient arithmetic processing by performing parallel processing of more data and hence is effective in a case where learning processing is performed a plurality of times by using an Artificial Intelligence (AI) model such as a neural network, or a case where many product-sum operations are performed in inference processing using a learned Artificial Intelligence (AI) model. An equivalent function may be implemented by a reconfigurable logic circuit called an FPGA, instead of the GPU 118. Processing executed by the GPU 118 may be performed in cooperation with the CPU 111 or may be performed by the CPU 111.

FIG. 2B is a block diagram exemplifying the functional configuration of the image processing apparatus 103 according to this embodiment.

The image processing apparatus 103 includes a first acquisition unit 201, a second acquisition unit 202, a first generation unit 203, a second generation unit 204, and a recording unit 205.

The functions of the first acquisition unit 201, the second acquisition unit 202, the first generation unit 203, and the second generation unit 204 of the image processing apparatus 103 are implemented by hardware shown in FIG. 2A and/or software programs executed by the CPU 111 or the GPU 118. The recording unit 205 of the image processing apparatus 103 is implemented by the ROM 112, the RAM 113, or the storage 114.

Note that each function of the image processing apparatus 103 according to this embodiment may be implemented by a single apparatus or may be divisionally implemented by a plurality of apparatuses as needed. In this case, the plurality of apparatuses are communicatively connected to each other.

The first acquisition unit 201 is communicatively connected to the first image capture apparatus 101, and acquires a first captured image from the first image capture apparatus 101. The second acquisition unit 202 is communicatively connected to the second image capture apparatus 102, and acquires a second captured image from the second image capture apparatus 102.

The first generation unit 203 performs image generation processing using a first generative AI model by receiving the first captured image as an input, and generates a first generated image. The second generation unit 204 performs image generation processing using a second generative AI model by receiving the second captured image and the first generated image as inputs, and generates a second generated image.

The recording unit 205 records the first generated image generated by the first generation unit 203 and the second generated image generated by the second generation unit 204. Each of the first captured image and the second captured image may be a still image or a moving image.

The image generation processing by the first generation unit 203 and the second generation unit 204 is implemented when the CPU 111 and/or the GPU 118 performs inference processing using a learned generative AI model.

The Artificial Intelligence (AI) model is formed by, for example, a Convolutional Neural Network (CNN), but is not limited to the CNN and may be formed by a neural network such as a transformer.

Note that instead of generating, by the first generation unit 203 and the second generation unit 204, the first and second generated images in which parts of the first and second captured images are reconstructed, respectively, the first generation unit 203 and the second generation unit 204 may generate partial images to be reconstructed in the first and second captured images and subsequently composite the partial images with the first and second captured images, thereby generating the first and second generated images, respectively.

### Control Processing

The control processing of the image processing apparatus 103 according to this embodiment will be described next with reference to FIG. 3.

The processing shown in FIG. 3 is implemented when the CPU 111 of the image processing apparatus 103 executes a program. Each function of the image processing apparatus 103 is implemented by the hardware and/or software of the image processing apparatus 103.

In step S301, the image processing apparatus 103 acquires the first captured image and the second captured image. The first acquisition unit 201 acquires the first captured image captured by the first image capture apparatus 101. The second acquisition unit 202 acquires the second captured image captured by the second image capture apparatus 102.

In step S302, the image processing apparatus 103 generates the first generated image. The first generation unit 203 performs image generation processing by receiving the first captured image acquired in step S301, and generates the first generated image. Details of the image generation processing will be described later.

In step S303, the image processing apparatus 103 generates the second generated image. The second generation unit 204 performs image generation processing by receiving the second captured image acquired in step S301 and the first generated image generated in step S302, and generates the second generated image. Details of the image generation processing will be described later.

This embodiment has explained an example in which the first acquisition unit 201 acquires the first captured image from the first image capture apparatus 101 and the second acquisition unit 202 acquires the second captured image from the second image capture apparatus 102, but the present disclosure is not limited to this. An image holding unit (not shown) may be provided, the first acquisition unit 201 may acquire the first captured image held in the image holding unit, and the second acquisition unit 202 may acquire the second captured image held in the image holding unit.

### Image Generation Processing

The image generation processing in steps S302 and S303 reconstructs an object in a part of the input image by a generative AI model using a method called inpainting.

In the image generation processing in step S302, the input unit 116 of the image processing apparatus 103 accepts a generation instruction from the user, and notifies the first generation unit 203 of the generation instruction from the user. The generation instruction from the user can be accepted in, for example, a script format like "a flower on the ground" or "a bird in the sky". In this case, the first generative AI model used by the first generation unit 203 is trained in advance so as to generate the first generated image by reconstructing the first captured image as an image in which there is a flower on the ground or there is a bird in the sky.

In the image generation processing in step S303, the second generation unit 204 receives the first generated image and a generation instruction from the user in addition to the second captured image. The second generative AI model used by the second generation unit 204 is trained so that the same object as that (for example, a flower on the ground or a bird in the sky) reconstructed in the first generated image is also reconstructed in the second generated image.

In the image generation processing in step S303, the second generation unit 204 need not receive a generation instruction from the user. In this case, in the training method of the second generation unit to be described later, training data includes no generation instruction.

In a case where the first captured image and the second captured image are moving images, the above-described image generation processing is applied to an image of each frame.

### Training Method of First Generative AI Model

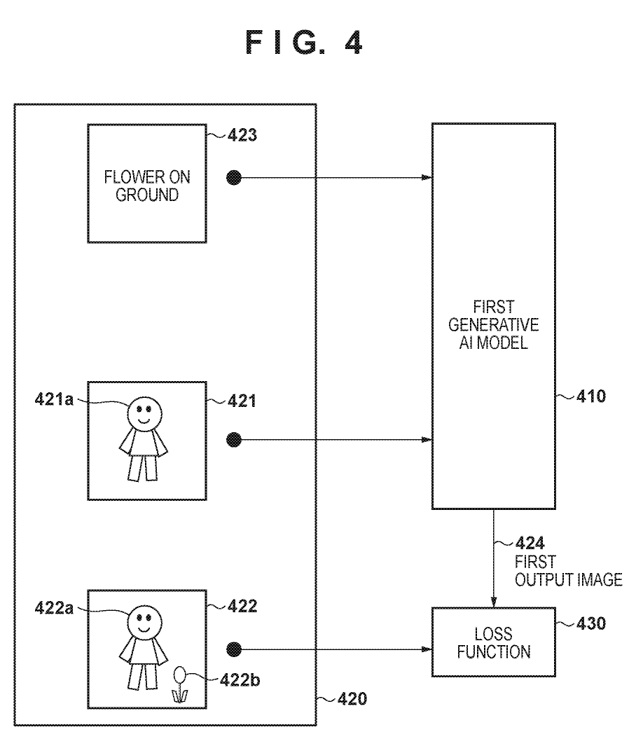

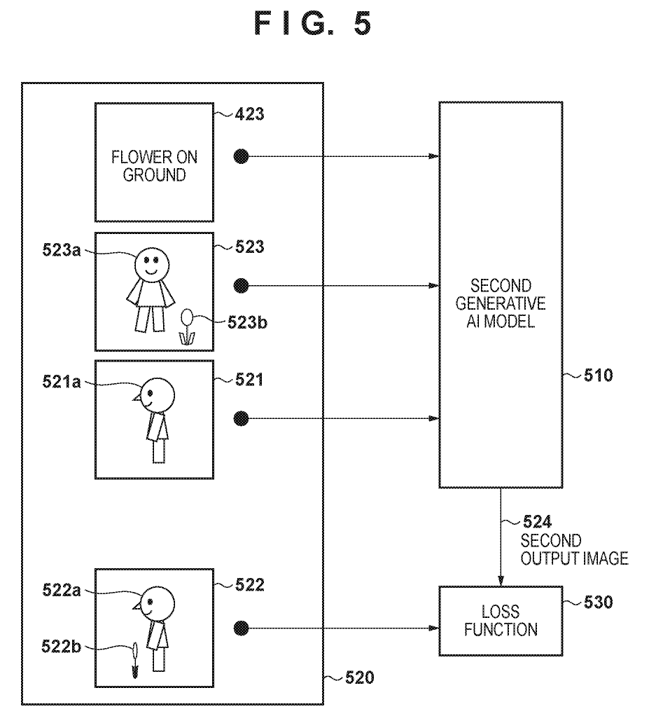

FIG. 4 is a view illustrating a method of training a first generative AI model 410 used in the image generation processing by the first generation unit 203.

The first generative AI model 410 is trained by repeating parameter adjustment a plurality of times. Parameter adjustment is performed based on training data 420. The training data 420 includes a first input image 421, a first target image 422, and a generation instruction 423.

The first generative AI model 410 performs learning processing by receiving the first input image 421 and the generation instruction 423 as inputs, and generates a first output image 424.

Next, parameter adjustment of the first generative AI model 410 is performed using the gradient of a loss function 430. Regarding the loss function 430, the first target image 422 and the first output image 424 are received, and, for example, the gradient of a target function is determined using backpropagation. Then, parameter adjustment of the first generative AI model 410 is performed using an arbitrary appropriate gradient descent optimization procedure, for example, Adam in accordance with the gradient of the target function.

The training data 420 is formed from a plurality of sets of the first input images 421, the first target images 422, and the generation instructions 423, and one of them will be described below.

The first generative AI model 410 according to this embodiment is trained so as to generate an output image by reconstructing a part of the input image based on the generation instruction from the user.

The generation instruction 423 corresponds to the generation instruction from the user, and is given in a script format like "a flower on the ground" or "a bird in the sky".

The first input image 421 is image data including a subject 421a. The first target image 422 is image data obtained by reconstructing a part of the first input image 421 based on the generation instruction 423. In the example shown in FIG. 4, the subject 421a included in the first input image 421 is also maintained as a subject 422a in the first target image 422, thereby reconstructing a scene in which a flower 422b is newly arranged on the ground.

The set of the first input image 421 and the first target image 422 can be generated by handling the same scene as different scenes depending on whether the flower 422b is included or not and performing Computer Graphics (CG) rendering of three-dimensional (3D) data.

In the example shown in FIG. 4, the first input image 421 is image data of a first scene (a scene in which no object is reconstructed) obtained by capturing the subject 421a from a first viewpoint (front), and is generated by rendering 3D data before reconstruction from the first viewpoint.

The first target image 422 is image data of a second scene (a scene in which the object is reconstructed) reconstructed by adding, to the first input image 421, the object 422b based on the generation instruction 423, and is generated by rendering 3D data after reconstruction from the first viewpoint.

The first generative AI model 410 adjusts a parameter so that the difference between the first target image 422 and the first output image 424 generated by inputting the first input image 421 and the generation instruction 423 becomes small.

### Training Method of Second Generative AI Model

FIG. 5 is a view illustrating a method of training a second generative AI model 510 used by the second generation unit 204.

The second generative AI model 510 is trained by repeating parameter adjustment a plurality of times. Parameter adjustment is performed based on training data 520. The training data 520 includes a second input image 521, a second target image 522, a reference image 523, and the generation instruction 423.

The second generative AI model 510 performs learning processing by receiving the second input image 521, the reference image 523, and the generation instruction 423, and outputs a second output image 524.

Next, parameter adjustment of the second generative AI model 510 is performed using the gradient of a loss function 530. Regarding the loss function 530, the second target image 522 and the second output image 524 are received, and, for example, the gradient of a target function is determined using backpropagation. Then, parameter adjustment of the second generative AI model 510 is performed using an arbitrary appropriate gradient descent optimization procedure, for example, Adam in accordance with the gradient of the target function.

The training data 520 is formed from a plurality of sets of the second input images 521, the second target images 522, the reference images 523, and the generation instructions 423, and one of them will be described below.

The second generative AI model 510 according to this embodiment is trained so as to generate an output image by reconstructing a part of the input image based on the reference image.

The generation instruction 423 corresponds to the generation instruction from the user, and is given in a script format including an object to be reconstructed and the position of the object like "a flower on the ground" or "a bird in the sky".

The second input image 521 is image data including a subject 521a. The second target image 522 is image data obtained by reconstructing a part of the second input image 521 based on the generation instruction 423. The reference image 523 corresponds to image data obtained by capturing the same scene as that of the second target image 522 from a different viewpoint. In the example shown in FIG. 5, the subject 521a included in the second input image 521 is also maintained as a subject 522a even in the second target image 522, thereby reconstructing a scene in which a flower 522b is newly arranged on the ground. Furthermore, a subject 523a and a flower 523b included in the reference image 523 correspond to image data obtained by capturing the subject 522a and the flower 522b included in the second target image 522 from a different viewpoint.

The set of the second input image 521, the second target image 522, and the reference image 523 can be generated by, for example, handling the same scene as different scenes from different viewpoints and different scenes depending on whether the flower 522b is included or not and performing CG rendering of 3D data.

By performing training by repeating parameter adjustment a plurality of times using a set of a plurality of image data with different scenes (the presence/absence of an object) and different viewpoints (front and side) before and after reconstruction, the second generative AI model 510 used by the second generation unit 204 is trained so as to also reconstruct, in the second generated image, the same object as that reconstructed in the first generated image with respect to various scenes.

In the example shown in FIG. 5, the second input image 521 is image data of the first scene (the scene in which no object is reconstructed) obtained by capturing the subject 521a from the second viewpoint (side), and is generated by, for example, rendering 3D data before reconstruction from the second viewpoint.

The second target image 522 is image data of the second scene (the scene in which the object is reconstructed) reconstructed by adding, to the second input image 521, the object 522b based on the generation instruction 423, and is generated by, for example, rendering 3D data after reconstruction from the second viewpoint.

The reference image 523 is image data of the second scene obtained by capturing the second target image 522 from the first viewpoint (front), and is generated by, for example, rendering the 3D data after reconstruction from the first viewpoint.

The second generative AI model 510 adjusts a parameter so that the difference between the second target image 522 and the second output image 524 generated by inputting the second input image 521, the reference image 523, and the generation instruction 423 becomes small.

As described above, according to the first embodiment, in a case where image generation is performed from each of a plurality of images with different viewpoints, it is possible to generate images that are consistent as images obtained by capturing the same scene.

### Second Embodiment

A second embodiment will be described next.

In the second embodiment, the position and orientation of an image capture apparatus are estimated from markers and used as input data for image generation processing.

### System Configuration

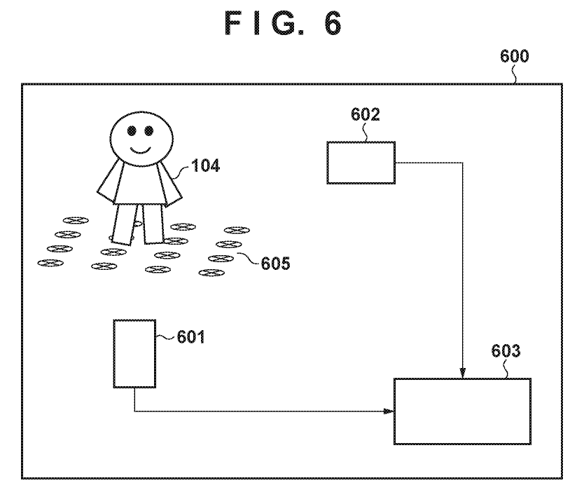

FIG. 6 is a view showing a system configuration according to the second embodiment.

An image capture system 600 according to this embodiment includes a first image capture apparatus 601, a second image capture apparatus 602, an image processing apparatus 603, and markers 605 provided on the floor where a subject exists.

The first image capture apparatus 601 and the second image capture apparatus 602 are arranged to capture a subject 104 from different viewpoints, and output captured images to the image processing apparatus 603. Some or all of the markers 605 are included in each of the image capture ranges of the first image capture apparatus 601 and the second image capture apparatus 602.

Each of the first image capture apparatus 601 and the second image capture apparatus 602 is a digital camera that captures an image such as a still image or a moving image.

The markers 605 may be provided in a location other than the location exemplified in this embodiment, such as a wall or ceiling, and may be provided in a plurality of locations.

### Apparatus Configuration

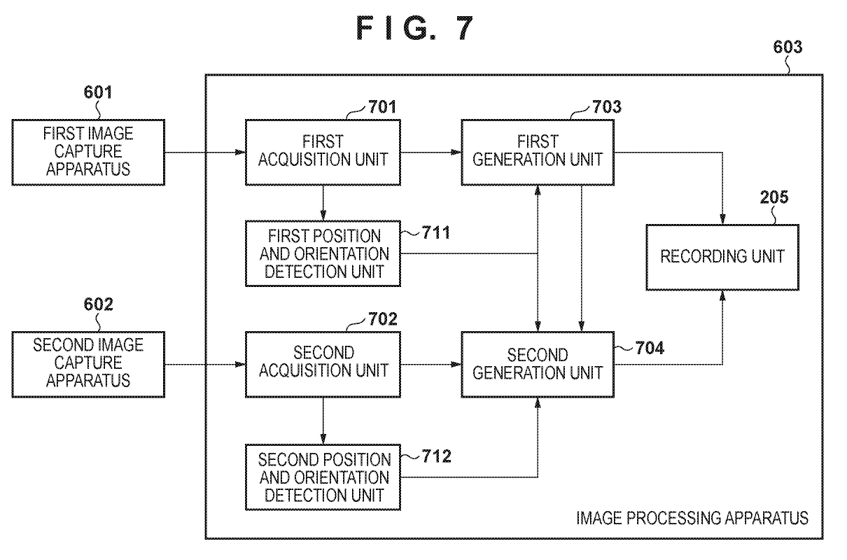

FIG. 7 is a block diagram exemplifying the functional configuration of the image processing apparatus 603 according to the second embodiment.

Note that the hardware configuration of the image processing apparatus 603 according to the second embodiment is the same as that shown in FIG. 2A of the first embodiment.

The image processing apparatus 603 includes a first acquisition unit 701, a second acquisition unit 702, a first generation unit 703, a second generation unit 704, a recording unit 205, a first position and orientation detection unit 711, and a second position and orientation detection unit 712.

The functions of the first acquisition unit 701, the second acquisition unit 702, the first generation unit 703, the second generation unit 704, the first position and orientation detection unit 711, and the second position and orientation detection unit 712 of the image processing apparatus 603 are implemented by hardware shown in FIG. 2A and/or software programs executed by a CPU 111 or a GPU 118. The recording unit 205 of the image processing apparatus 603 is implemented by a ROM 112, a RAM 113, or a storage 114.

Note that each function of the image processing apparatus 603 according to this embodiment may be implemented by a single apparatus or may be divisionally implemented by a plurality of apparatuses as needed. In this case, the plurality of apparatuses are communicatively connected to each other.

The first acquisition unit 701 is communicatively connected to the first image capture apparatus 601, and acquires a first captured image captured by the first image capture apparatus 601. The second acquisition unit 702 is communicatively connected to the second image capture apparatus 602, and acquires a second captured image captured by the second image capture apparatus 602.

The first position and orientation detection unit 711 detects first viewpoint information including position information and orientation information of the first image capture apparatus 601. The second position and orientation detection unit 712 detects second viewpoint information including position information and orientation information of the second image capture apparatus 602.

The first generation unit 703 performs image generation processing using a first generative AI model by receiving the first captured image and the first viewpoint information as inputs, and generates a first generated image. The second generation unit 704 performs image generation processing using a second generative AI model by receiving the second captured image, the first viewpoint information, the second viewpoint information, and the first generated image as inputs, and generates a second generated image.

The recording unit 205 records the first generated image generated by the first generation unit 703 and the second generated image generated by the second generation unit 704. Each of the first captured image and the second captured image may be a still image or a moving image.

The image generation processing by the first generation unit 703 and the second generation unit 704 is implemented when the CPU 111 and/or the GPU 118 performs inference processing using a learned generative AI model.

### Control Processing

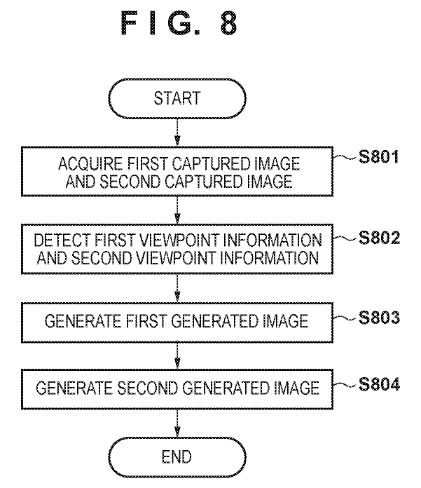

The control processing of the image processing apparatus 603 according to this embodiment will be described next with reference to FIG. 8.

The processing shown in FIG. 8 is implemented when the CPU 111 of the image processing apparatus 603 executes a program. Each function of the image processing apparatus 603 is implemented by the hardware and/or software of the image processing apparatus 603.

In step S801, the image processing apparatus 603 acquires the first captured image and the second captured image. The first acquisition unit 701 acquires the first captured image captured by the first image capture apparatus 601. The second acquisition unit 702 acquires the second captured image captured by the second image capture apparatus 602. Each of the first captured image and the second captured image acquired by the first acquisition unit 701 and the second acquisition unit 702 includes some or all of the markers 605.

In step S802, the image processing apparatus 603 detects the first viewpoint information and the second viewpoint information. The first position and orientation detection unit 711 detects the first viewpoint information including the position information and orientation information of the first image capture apparatus 601 based on the markers 605 included in the first captured image. The second position and orientation detection unit 712 detects the second viewpoint information including the position information and orientation information of the second image capture apparatus 602 based on the markers 605 included in the second captured image. The position information and orientation information can be acquired by arbitrarily using a known method.

In step S803, the first generation unit 703 generates the first generated image. The processing in step S803 is the same as that in step S302 of FIG. 3.

In step S804, the second generation unit 704 generates the second generated image. The second generation unit 704 performs the image generation processing using the second generative AI model by receiving, as inputs, the second captured image acquired in step S801, the first viewpoint information and the second viewpoint information acquired in step S802, and the first generated image generated in step S803, and generates the second generated image. Details of the image generation processing will be described later.

In a case where the first captured image and the second captured image are moving images, the above-described image generation processing is applied to an image of each frame.

The first image capture apparatus 601 and the second image capture apparatus 602 may be arranged so that one of the image capture ranges of these apparatuses includes the subject 104 and the other image capture range includes some or all of the markers 605.

A bird's-eye view camera that overlooks the first image capture apparatus 601, the second image capture apparatus 602, the subject 104, and some of the markers 605 may be provided, and the first viewpoint information and the second viewpoint information may be detected from an image of the bird's-eye view camera.

### Image Generation Processing

The image generation processing in steps S803 and S804 reconstructs an object in a part of the input image by a generative AI model using a method called inpainting.

The image generation processing in step S803 is the same as that in step S302 of FIG. 3.

In step S804, the second generation unit 704 receives the first generated image in addition to the second captured image. The second generation unit 704 further receives the first viewpoint information and the second viewpoint information detected in step S802. In addition, the second generation unit 704 receives the same generation instruction from the user as in step S803. In this case, the second generative AI model used by the second generation unit 704 is trained so that the same object as that (for example, a flower on the ground or a bird in the sky) reconstructed in the first generated image is also reconstructed in the second generated image. Furthermore, the second generation unit 704 can more correctly reconstruct the image data based on the first viewpoint information and the second viewpoint information.

In step S804, the second generation unit 704 need not receive the generation instruction from the user. In this case, in the training method of the second generative AI model to be described later, training data includes no generation instruction.

In a case where the first captured image and the second captured image are moving images, this processing is applied to each frame.

The training method of the first generative AI model is as described above with reference to FIG. 4 of the first embodiment.

### Training Method of Second Generative AI Model

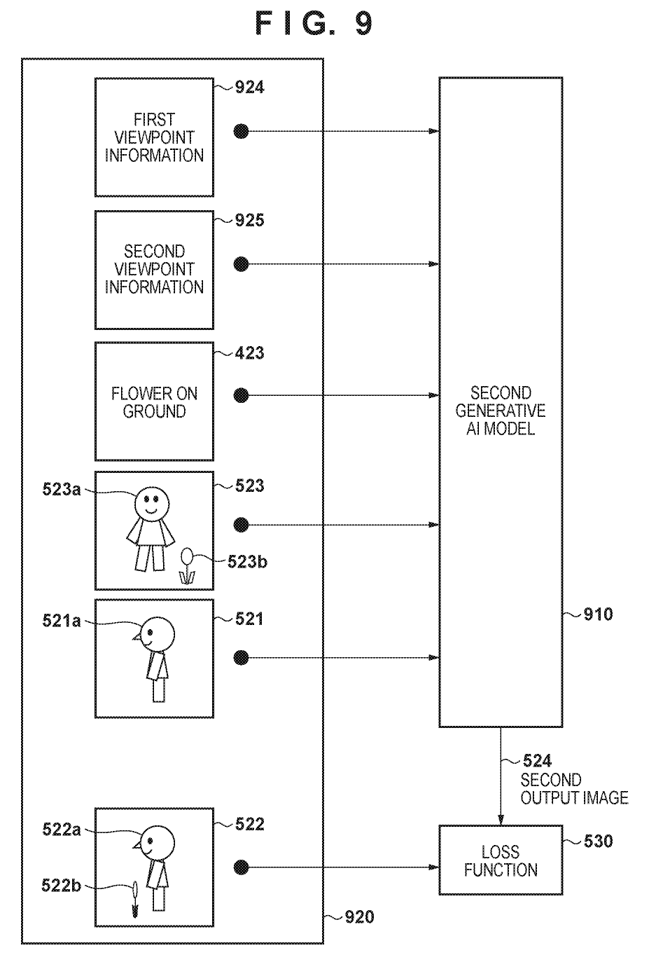

FIG. 9 is a view illustrating a method of training a second generative AI model 910 used by the second generation unit 704.

The second generative AI model 910 is trained by repeating parameter adjustment a plurality of times. Parameter adjustment is performed based on training data 920. The training data 920 includes a second input image 521, a second target image 522, a reference image 523, first viewpoint information 924, second viewpoint information 925, and a generation instruction 423.

The second generative AI model 910 performs learning processing by receiving the second input image 521, the reference image 523, the first viewpoint information 924, the second viewpoint information 925, and the generation instruction 423, and outputs a second output image 524.

Next, parameter adjustment of the second generative AI model 910 is performed using the gradient of a loss function 530. Regarding the loss function 530, the second target image 522 and the second output image 524 are received, and, for example, the gradient of a target function is determined using backpropagation. Then, parameter adjustment of the second generative AI model 910 is performed using an arbitrary appropriate gradient descent optimization procedure, for example, Adam in accordance with the gradient of the target function.

The training data 920 is formed from a plurality of sets of the second input images 521, the second target images 522, the reference images 523, the pieces of first viewpoint information 924, the pieces of second viewpoint information 925, and the generation instructions 423, and one of them will be described below.

The second generative AI model 910 according to this embodiment is trained so as to generate an output image by reconstructing a part of the input image based on the reference image.

The generation instruction 423 corresponds to the generation instruction from the user, and is given in a script format like "a flower on the ground" or "a bird in the sky".

The second input image 521 is image data including a subject 521a. The second target image 522 is image data obtained by reconstructing a part of the second input image 521 based on the generation instruction 423. The reference image 523 corresponds to image data obtained by capturing the same scene as that of the second target image 522 from a different viewpoint.

The first viewpoint information 924 includes the position information and orientation information of the image capture apparatus when capturing the reference image 523. The second viewpoint information 925 includes the position information and orientation information of the image capture apparatus when capturing the second input image 521 and the second target image 522. In the example shown in FIG. 9, the subject 521a included in the second input image 521 is also maintained as a subject 522a in the second target image 522, thereby reconstructing a scene in which a flower 522b is newly arranged on the ground.

Furthermore, a subject 523a and a flower 523b included in the reference image 523 correspond to image data obtained by capturing the subject 522a and the flower 522b included in the second target image 522 from a different viewpoint.

The set of the second input image 521, the second target image 522, and the reference image 523 can be generated by, for example, handling the same scene as different scenes from different viewpoints and different scenes depending on whether the flower 522b is included or not and performing CG rendering of 3D data.

By performing training by repeating parameter adjustment a plurality of times using a set of a plurality of image data with different scenes (the presence/absence of an object) and different viewpoints (front and side) before and after reconstruction, the second generative AI model 910 used by the second generation unit 704 is trained so as to also reconstruct, in the second generated image, the same object as that reconstructed in the first generated image with respect to various scenes.

Note that the second embodiment has explained an example in which viewpoint information is detected, as image capture information of the image capture apparatus, from the position information and orientation information of the image capture apparatus, but viewpoint information may be detected using one of the position information and orientation information of the image capture apparatus, and may be detected using, for example, angle-of-view or f-number information.

In the example shown in FIG. 9, the second input image 521 is image data of a first scene (the absence of the object) obtained by capturing the subject 521a from a second viewpoint (side), and is generated by, for example, rendering the second input image 521 as 3D data before reconstruction from the second viewpoint.

The second target image 522 is image data of a second scene (the presence of the object) reconstructed by adding, to the second input image 521, the object 522b based on the generation instruction 423, and is generated by, for example, rendering 3D data after reconstruction from the second viewpoint.

The reference image 523 is image data of the second scene obtained by capturing the second target image 522 from the first viewpoint (front), and is generated by, for example, rendering the 3D data after reconstruction from the first viewpoint.

The second generative AI model 510 adjusts a parameter so that the difference between the second target image 522 and the second output image 524 generated by inputting the second input image 521, the reference image 523, and the generation instruction 423 becomes small.

As described above, according to the second embodiment, in a case where image generation is performed from each of a plurality of images with different viewpoints, it is possible to generate images that are consistent as images obtained by capturing the same scene.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-070797, filed Apr. 22, 2025 which is hereby incorporated by reference herein in its entirety.

What is claimed is:

1. An image processing apparatus comprising:
at least one processor; and
at least one memory which stores a program which, when executed by the at least one processor, causes the image processing apparatus to function as:
a first generation unit that generates a first generated image based on a first image; and
a second generation unit that generates a second generated image based on the first generated image and a second image,
wherein the first generation unit and the second generation unit respectively generate the first generated image and the second generated image using a generative AI model trained so as to generate an output image by reconstructing a part of an input image.

2. The apparatus according to claim 1, wherein
the first generation unit generates the first generated image using a first generative AI model and a parameter, and
the first generative AI model
is trained by receiving, as an input, a first input image of a first scene obtained by capturing a subject from a first viewpoint, and
the parameter of the first generative AI model is adjusted so that a difference between a first output image generated by the first generative AI model by receiving the first input image as an input and a first target image of a second scene obtained by reconstructing a part of the first input image becomes small.

3. The apparatus according to claim 2, wherein the first target image is generated by rendering, from the first viewpoint, 3D data in which a part of the first input image is reconstructed.

4. The apparatus according to claim 1, wherein
the second generation unit generates the second generated image using a second generative AI model and a parameter, and
the second generative AI model
is trained by receiving, as inputs, a second input image of a first scene obtained by capturing a subject from a second viewpoint and a reference image of a second scene obtained by capturing, from a first viewpoint, a second target image of a second scene obtained by reconstructing a part of the second input image, and
the parameter of the second generative AI model is adjusted so that a difference between the second target image and a second output image generated by the second generative AI model by receiving the second input image and the reference image as inputs becomes small.

5. The apparatus according to claim 4, wherein
the second input image is generated by rendering, from the second viewpoint, 3D data in which a part of an image is not reconstructed,
the second target image is generated by rendering, from the second viewpoint, 3D data in which a part of the second input image is reconstructed, and
the reference image is generated by rendering, from the first viewpoint, 3D data in which a part of the second input image is reconstructed.

6. The apparatus according to claim 1, wherein
the first image is an image captured by a first image capture unit, and
the second image is an image captured by a second image capture unit with a viewpoint different from a viewpoint of the first image capture unit.

7. The apparatus according to claim 2, wherein the first generation unit generates the first generated image by the first generative AI model further based on image capture information concerning the first image.

8. The apparatus according to claim 7, wherein the image capture information includes any one of pieces of information concerning a position, an orientation, an angle of view, and an f-number of an image capture apparatus.

9. The apparatus according to claim 7, wherein the first generation unit generates the first generated image by the first generative AI model further based on a generation instruction from a user.

10. The apparatus according to claim 4, wherein
the second generative AI model is trained by further receiving, as an input, a generation instruction from a user.

11. The apparatus according to claim 4, wherein the second generation unit generates the second generated image by the second generative AI model further based on image capture information concerning the first image and image capture information concerning the second image.

12. The apparatus according to claim 11, wherein the image capture information further includes any one of pieces of information concerning a position, an orientation, an angle of view, and an f-number of an image capture apparatus.

13. The apparatus according to claim 11, wherein the second generative AI model is trained by further receiving, as inputs, image capture information concerning the second input image and image capture information concerning the reference image.

14. The apparatus according to claim 11, wherein the second generation unit generates the second generated image by the second generative AI model further based on a generation instruction from a user.

15. The apparatus according to claim 11, wherein
markers are provided in an image capture range of a first image capture unit that captures the first image and an image capture range of a second image capture unit that captures the second image,
the apparatus includes
a first detection unit that detects first viewpoint information including position information and orientation information of the first image capture unit from the markers included in the first image, and
a second detection unit that detects second viewpoint information including position information and orientation information of the second image capture unit from the markers included in the second image, and
the second generation unit generates the second generated image by the second generative AI model further based on the first viewpoint information and the second viewpoint information as the image capture information.

16. The apparatus according to claim 11, wherein
a camera that overlooks a first image capture unit that captures the first image and a second image capture unit that captures the second image is provided,
first viewpoint information including position information and orientation information of the first image capture unit and second viewpoint information including position information and orientation information of the second image capture unit are detected from an image of the camera, and
the second generation unit generates the second generated image by the second generative AI model further based on the first viewpoint information and the second viewpoint information as the image capture information.

17. An image processing method executed by an image processing apparatus comprising:
generating a first generated image based on a first image; and
generating a second generated image based on the first generated image and a second image,
wherein in the generating, the first generated image and the second generated image are generated using a generative AI model trained so as to generate an output image by reconstructing a part of an input image.

18. A non-transitory computer-readable storage medium storing a program for causing a computer to function as an image processing apparatus comprising:
a first generation unit that generates a first generated image based on a first image; and
a second generation unit that generates a second generated image based on the first generated image and a second image,
wherein the first generation unit and the second generation unit respectively generate the first generated image and the second generated image using a generative AI model trained so as to generate an output image by reconstructing a part of an input image.
